(19) United States
(12) Patent Application Publication
(10) Pub. No.: US 2026/0257149 A1
(43) Pub. Date: Sep. 3, 2026

(54) CONTAINER INCLUDING AN ACTIVE MATRIX FOR A FLUID FILTER ASSEMBLY

(71) Applicant: CECO ENVIRONMENTAL IP INC., Dallas, TX (US)

(72) Inventors: Carl William HAHN, Dallas, TX (US); Mathews Joshua THUNDYIL, Dallas, TX (US); William Roy MCDONIEL, Dallas, TX (US); Johnny Keith BASS, Dallas, TX (US); Joel Matthew GARRETT, Dallas, TX (US); Tom Bodley STIBOLT, Dallas, TX (US); Brian Leon NEEL, Dallas, TX (US)

(21) Appl. No.: 19/067,408

(22) Filed: Feb. 28, 2025

(51) Int. Cl. B01D 15/00; B01D 49/00

(52) U.S. Cl. CPC B01D 15/00; B01D 49/00; B01D 2253/102

(57) ABSTRACT

A fluid filter assembly includes a container comprising an active matrix therein for purifying a fluid, a first filter upstream of the active matrix configured to remove a portion of a fluid, and a second filter downstream of the active matrix, wherein the active matrix and the second filter are comprised in a vessel.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND

There are many processes employing activated carbon for fluid purification, such as aqueous amine systems utilized for acid gas removal from natural gas or combustion gas scrubbing, glycol systems for dehydration of natural gas streams, and other solvent purification systems. The activated carbon can adsorb soluble contaminants, decomposition products or color bodies from the circulating solvent stream.

### SUMMARY

In some embodiments, a fluid filter assembly comprises a container comprising an active matrix therein for purifying a fluid; a first filter upstream of the active matrix; and a second filter downstream of the active matrix, wherein the active matrix and the second filter are comprised in a vessel.

In some embodiments, a process for purifying a fluid comprises: passing the fluid to a first filter to obtain a filtered fluid; passing the filtered fluid to a container comprising an active matrix therein to obtain a purified fluid; and passing the purified fluid to a second filter for removing active matrix fines to obtain a purified product, wherein the container and the second filter are comprised in a vessel.

In some embodiments, a container for purifying a fluid comprises: a first filter contained within a first chamber; an absorbent matrix contained within a second chamber; a second filter contained within a third chamber, wherein the first chamber is coupled to and upstream of the second chamber and the second filter in the third chamber is coupled to and downstream of the second chamber.

These and other features will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic of an embodiment of a filter assembly.

FIG. 2 is a schematic of an embodiment of another filter assembly including a container.

FIG. 3 is a schematic of another embodiment of a container for purifying a fluid in an up-flow.

FIG. 4 is a schematic of a further embodiment of a container for purifying a fluid in a down-flow.

FIG. 5 is a schematic elevational view of an embodiment of a vessel including a plurality of containers.

FIG. 6 is a schematic, cross-sectional view of the embodiment of the vessel including a plurality of containers highlighting a support plate and inlet baffle.

FIG. 7 is a schematic, perspective view of another embodiment of a vessel including a plurality of containers with an inlet and an outlet on the same side of the vessel.

### DETAILED DESCRIPTION

Generally, some embodiments disclosed herein provide a filter assembly for a fluid (e.g., a liquid and/or gas) having a first filter upstream of an active matrix, such as adsorbent, e.g., an activated carbon, which is upstream of a second filter. Generally, the first filter removes particulate contaminants to prevent plugging of the active matrix and the second filter removes particulates such as fines attrited from the activated matrix from a purified product. Usually, the active matrix and second filter, and optionally the first filter, are housed in a common vessel or container to increase the efficiency of maintaining the filter assembly and reduce capital costs. In some embodiment, the downstream second filter is installed directly into a carbon filter vessel. This installation can be achieved by flowing vertically through a cartridge filter containing granular activated carbon, then through an outside-to-inside flowing cartridge filter.

Traditional carbon type filters also tend to load an absorbent into a contacting chamber. Disclosed herein is a cartridge to contain the filter elements. The use of a cartridge for the absorbent and/or one or more of the particulate filters can allow the filtration element(s) to be easily changed. This can avoid downtime to clean and replace the filter elements. Overall, the system disclosed herein can shrink the footprint of the filtration system by having a reduced number of filtration vessels (e.g., one or two versus three in a traditional system), making the system easier to maintain, having a simpler control system due to using fewer vessels, and making the absorbent easier to dispose of by retaining it within a filter element or cartridge.

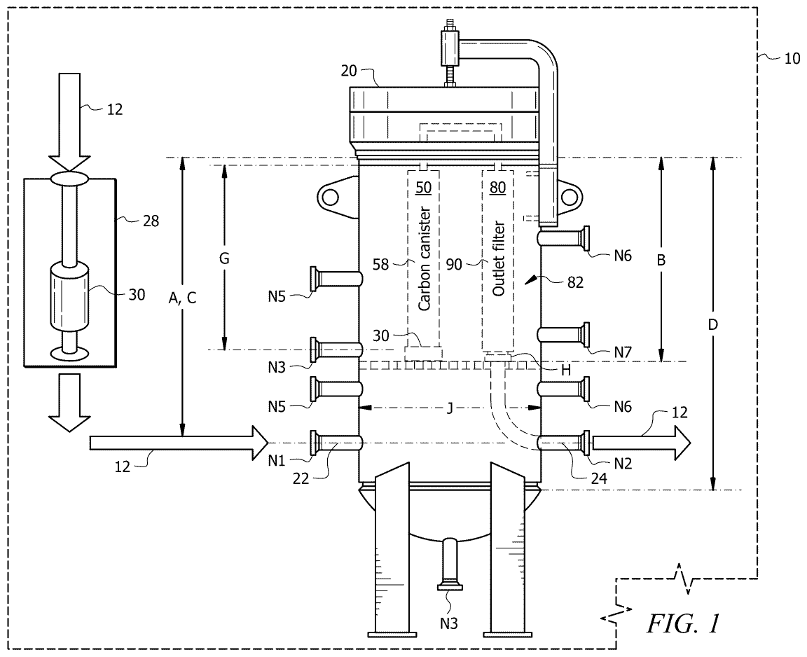

Referring to FIG. 1, a filter assembly 10, such as a fluid filter assembly, in some embodiments is disclosed. The filter assembly 10 comprises a housing or vessel 20 and optionally a prefilter vessel 28. Generally, the filter assembly 10 comprises one or more containers, such as a first container 50, and a second container 80 disposed within the vessel 20. The vessel 20 can comprise multiple connection points or ports. In some embodiments, the vessel 20 can have nozzles N1-N3 to N5-N7. and distances between various parts and/or sections by the indicia “A”, “B”, “C”, “D”, “G”, and “J”. Typically, an inlet 22 can serve to receive fluids, and an outlet 24 can pass a filtered fluid out of the vessel 20. In some embodiments, the inlet 22 and the outlet 24 can be substantially aligned along a common axis (e.g., in a straight line) so that the entire vessel 20 can be placed in line with fluid piping. The vessel can also comprise one or more additional ports such as a drain port, vent port to allow for filling of the vessel 20, and multiple access ports for sensors.

The vessel 20 can be configured with various internal structures configured to receive a fluid to be filtered, pass the fluid through a first filter 30 and then passed to a second filter 90. As shown in FIG. 1, a lower flange can be present in the vessel 20 to separate the fluid inlet chamber from the fluid within the filtration chamber. A top flange can also be used within the vessel 20 to create an upper chamber. A vessel cover can be placed at the top of the vessel 20 and sealingly coupled to the body of the vessel 20, thereby forming a sealed vessel. A seal or other type of gasket can be used for provide a fluid tight vessel when the vessel cover is in the closed position so that fluid will only communicate through the one or more ports such as inlet 22 and outlet 24. The lower flange and upper flange can create a fluid flow path through the vessel 20 from the inlet chamber, through the filtration chamber, through the first filter, through the second filter, and then to the outlet 24, as described in more detail herein.

The first container 50, such as a cannister, can be configured to retain an active matrix 58 and/or one or more filter elements. In some embodiments, the prefilter vessel 28 comprises a first filter 30 upstream of the active matrix 58 and the second container 80 includes a second filter 90 downstream of the active matrix 58.

The active matrix 58 can comprise any suitable composition and structure to remove one or more components passing through the first container 50. For example, the active matrix can absorb, adsorb, and/or filter one or more components such as chemical component, particulate, or the like from the fluid passing through the first container 50. The active matrix 58 can include adsorbent material, which can include a fuller's earth, a clay, a diatomaceous earth, one or more absorbent resin beads, a macroreticular resin, an ion exchange resin, a catalyst, a molecular sieve, an activated carbon, or a combination thereof. Preferably the adsorbent material comprises an activated carbon, such as a granular activated carbon. While any suitable amount of adsorbent material can be used, in some aspects, the first container 50 can comprise at least about 1 lb, at least 5 lbs, at least 6 lbs, at least 10 lbs, at least 20 lbs, or at least 30 lbs of adsorbent. In some aspects, the first container 50 can comprise less than about 60 lbs, less than about 50 lbs, less than about 40 lbs, less than about 30 lbs, or less than about 20 lbs of adsorbent. In some aspects, the first container 50 can have a diameter between about 4 to about 60 inches, and can be sized based on the vessel 20 size, and the overall weight of the first container 50 to allow for handling and replacement of the first container 50 and/or any individual components thereof as needed. For example, the entire first container 50 can be replaced, or alternatively, a particulate filter or the active matrix can be individually replaced.

Generally, the cannister 50 can be cylindrical in shape but is not limited to any particular shape. In some aspects, the active matrix 58 can be arranged radially in the first container 50, such as a cannister 50. A central support or perforated tube can be placed centrally within the cannister 50 to allow fluid to pass into the central portion of the cannister and radially outwards through the active matrix 58. In some embodiments, the active matrix 58 can fill a central portion of the cannister 50 and a flow path can be formed through active matrix 58 axially or longitudinally along the length of the cannister 50 through the active matrix 58.

The first filter 30 and the second filter 90 can comprise a filtration element, which can include a flexible material or media capable of being formed into tubes, sheets, rolls using a pleated filter, melt-blown, spun-bonded, or formed porous media. Examples of such materials can include, but are not limited to, paper, polypropylene, cellulose, polytetrafluoroethylene, tetrafluoroethylene, and other synthetic materials. The porosity and/or thickness of the filter sheet may be selected depending on the materials desired to be removed from the fluid. Examples of porosities may range from about 0.5 micron to about 200 microns. Examples of thicknesses of the filter media may range from about 0.5 millimeter (mm) to about 3 mm. A surface area of the filter media may range from about 0.05 to about 0.8, or from about 0.1 to about 0.5 meters squared (m²) per meter-length of the filter media along an axial direction of the tube. In some embodiments, the filter media may have a surface area of up to about 4 m² per meter-length, or from about 0.0001 to about 4 m² per meter-length of the filter media along an axial direction of the tube when using pleated media. The filter media (and the first filter 30 or second filter 90) may be configured to receive fluid to be filtered at a flow rate ranging from 0 cubic meters per hour (m³/h) to 25 m³/h, or up to about 10 m³/h. In some embodiments, filter elements in the first filter 30 or the second filter 90 can have, independently, a diameter between about 40 mm and about 300 mm, or from about 50 mm to about 210 mm.

The vessel 20 can comprise any suitable pressure vessel capable of retaining the filter elements. The vessel 20 may comprise supports and/or one or more access ports to allow the various filter elements and media to be replaced. While shown as a vertical vessel in FIG. 1, any suitable shape and orientation can be used. For example, the vessel 20 can be a horizontal vessel, a spherical vessel, and/or have a non-circular cross section.

In operation, a fluid 12 can pass into the prefilter vessel 28 through the first filter 30 removing particulates to prevent plugging of the active matrix 58. Next, the fluid 12 can enter an inlet 22 into the vessel 20. The fluid 12 can enter the first container 50 and pass axially through the active matrix, typically in the form of a bed, for removing, such as adsorbing impurities, one or more solid impurities, decomposition products, color bodies, or a combination thereof. After passing through the active matrix 58, the fluid 12 can pass from the first container 50 and into the second container 80, which contains the second filter 90. After passing through the second filter 90, the fluid 12 exits an outlet 24.

The filter assembly 10 can be operated to remove one or more components of the fluid such as a particulate material and/or one or more chemical components. The filter assembly 10 can operate until a capacity of the filter is reached. In general, the capacity of the particulate filters can be matched to the absorbent capacity of the active matrix, though one of the two can often be exceeded first. The filter assembly 10 can be associated with various sensors such as one or more pressure sensors configured to read a pressure upstream and downstream of the filter assembly 10 and/or containers, and/or chemical sensors configured to detect a component within the fluid being filtered (e.g., downstream of the filter assembly 10 and/or containers). When a replacement threshold such as a differential pressure across the filters exceeds a threshold, the particulate filters may be clogged and be replaced. Similarly, if the chemical sensors detect a component being adsorbed remaining in the fluid above a threshold, the active matrix may be loaded and need to be replaced. In some aspects, the chemical sensor can comprise a chemical analyzer, color sensor, physical property sensors (e.g., a viscometer, etc.), or any other suitable sensor configured to measure a chemical component or a property correlated with a chemical component. In some aspects, the filter assembly 10 may have the filter elements replaced based on a usage time and/or volumetric filtration capacity, which can be based on the expected capacity of the filter elements and active matrix. When the system detects a replacement threshold, the filter element may be replaced.

In some embodiments, the filter assembly 10 omits the prefilter vessel 28 containing the first filter 30 and the first filter 30 is coupled to, preferably formed integrally with the first container 50. In some embodiments, the first filter 30, the active matrix 58, and the second filter 90 are all contained within the vessel 20. In this embodiment, the filter assembly 10 can operate as described above.

In some embodiments, the consolidated active matrix 58, such as a carbon filter and particle filter arrangement can minimize capital cost and reduce equipment footprint. Moreover, the arrangement as shown in FIG. 1 can allow both the first container 50, such as a carbon canister filter, and the second container 80, such as a particle removal filter cartridge, to reside in the same vessel envelope and in the same plane within the vessel 20. This arrangement allows retention as well as replacement of the elements simple for the operator. Additionally, the inlet 22 and the outlet 24 can be positioned in the same plane aligning the vessel 20 with the process piping simplifing piping layout and design to minimize elbows and couplings.

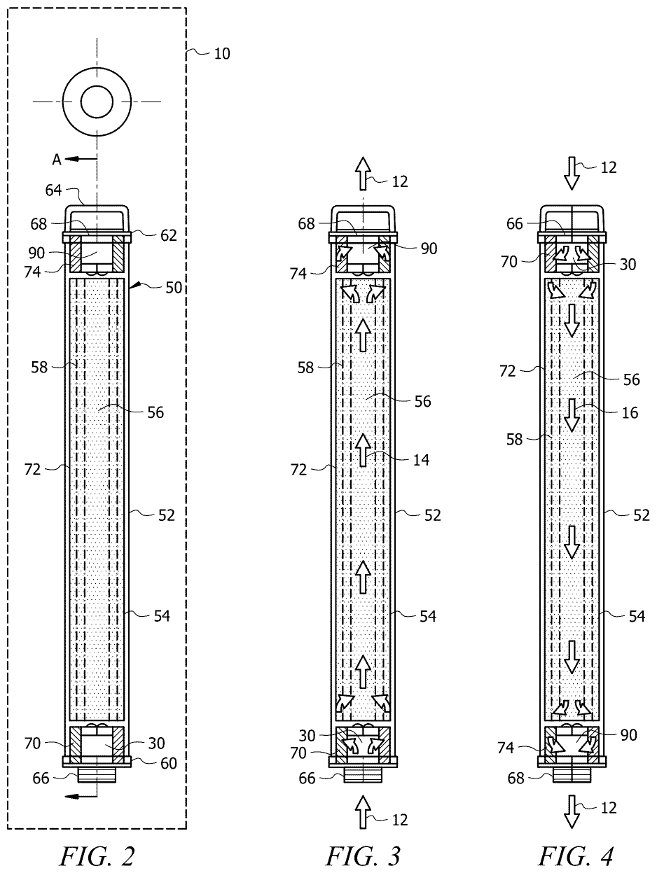

Referring to FIG. 2, depicts a top view and underneath a cross-sectional view along “A” underneath. In some embodiments, a plurality of filters 30 and 90 can be combined with the active matrix 58 in the same container 50, such as a cannister 52, in a filter assembly 10. As such, the active matrix 58, such as an activated carbon, can be integrated pre-and post-filtration. Particularly, the cannister 52 can have an outer wall or boundary 54, a center 56, a first end 60, a second end 62, an inlet 66, and an outlet 68. The inlet 66 can be integrally formed in the housing of the first end 60, and the outlet 68 can be integrally formed in the housing of the second end 62.

In some embodiments, the second end 62 can be coupled to, such as formed integrally with, an optional handle 64. The handle 64 can facilitate transport of the container 50 for installing and removing the container 50 from, e.g., a vessel. In some aspects, the first end 60 can be configured to form an engagement that can support or maintain the filter assembly 10 in alignment and support the filter assembly 10 within a filtration vessel (e.g., vessel 20 of FIG. 1). For example, the engagement can comprise threads, a shoulder, or other structure configured to seat or engage a corresponding coupling element within the vessel. In some aspects, a seal or other element can be used to provide a sealing engagement between the inlet 66 and the coupling point within the vessel. For example, the end 60 can have an inlet protrusion and the another end 62 can have an outlet protrusion each with dual O-ring seals to connect to the, respectively, the first chamber 70 and the third chamber 74. In some embodiments, different interface types are possible to seal the chambers 70 and/or 74, e.g., protrusions, inserts, threaded couplings, or a combination thereof. The resulting configuration can force a fluid to enter the filter assembly 10 through the inlet 66, pass through the filtration elements, and pass out of the filter assembly 10 through the outlet 68.

The container 50 can include a first chamber 70, a second chamber 72, and a third chamber 74. The first chamber 70 can be fluidly coupled to the second chamber 72, in turn fluidly coupled to the third chamber 74. Generally, the first chamber 70 can contain the first filter 30, the second chamber 72 can contain the active matrix 58, and the third chamber 74 can contain the second filter 90 where each of the first filter 30, the active matrix 58, and the second filter 90 can have a cylindrical shape. The first filter 30, active matrix 58, and the second filter 90 can be as described above.

In some embodiments each of the first filter 30 and second filter 90 can be a filter cartridge (e.g., a pleated filter, melt-blown, spun-bonded, or formed porous media, etc.) positioned at the top and bottom of the container 50 and configured to filter particulates from a fluid. An annular space can exist between each of the first filter 30 and the second filter 90 and the outer wall or boundary 54 of the container 50 to allow fluid flow axially within the container 50. Flow can occur in either direction, such as top-down or bottom-up. The container can be oriented in any direction, e.g., horizontally, vertically or at any angle. As depicted in FIG. 2, the end 60 can receive an embedded filter element.

In some embodiments, a first filter 30, such as a pleated cartridge, can be affixed to the first end 60. Alternatively, the first filter 30 can also be non-pleated material suitable for achieving particulate filtration, such as a formed element, a wound element, etc. As depicted in FIG. 2, the center 56 can be a section of granular activated carbon acting as an adsorbent bed. The design can utilize any adsorbent material or active matrix, or combinations thereof, e.g., fuller's earth, clay, diatomaceous earth, absorbent resin beads, macroreticular resin, ion exchange resin, catalyst, molecular sieve, or any combination thereof. In some embodiments, the adsorbent can either be in a free state, contained within a bag or capsule, formed into a block, and/or or immobilized on a filtration material.

In some embodiments, the container 50 can include the second end 62, which can be an end cap, into which the second filter 90 is embedded. As depicted in FIG. 2, the upper end cap can contain an integral handle allowing gripping of the container 50 easier for operators and simplifies installation and/or removal. The top end cap can have, depending whether the configuration is down-flow or up-flow, an inlet or an outlet hole to allow fluid flow axially through the container 50. The first and second filters 30 and 90, such as pre-and post-filters, can either be part of the container 50 or can be separate components assembled to form an integral element. In some embodiments, two end caps can be connected by a solid outer tube to contain the adsorbent bed and direct the fluid flow axially through the element.

In some embodiments, the adsorbent canister with integral pre-and post-filters can perform three functions, namely pre-filtration, adsorption, and post-filtration in a single container or device. Traditionally, the three functions have been separated into separate vessels. The integral element minimizes the number of vessels required, capital costs, footprint of the system and complexity, such as reducing the number of valves, instruments, nozzles, connections, etc. Additionally, the integration of the components simplifies maintenance, as only one element is changed rather than three independent elements or canisters, as well as inventory of spare parts.

Additionally, in some embodiments, to axial flow through the active matrix 58, a radial design with the adsorbent material contained between radially arranged filter sections may also be used. The radial design can have an orifice in one or both ends of the container connected by a center perforated or porous core and an outer perforated or porous core, with the pre-and post-filters separated by an adsorbent bed. However, numerous vessel arrangements and nozzle orientations are possible in some embodiments.

Referring to FIGS. 3-4, the filter assembly 10 in some embodiments can be operated in up-flow 14 or down-flow 16. Referring to FIG. 3, the cannister 52 in some embodiments can have an inlet 66 receiving the fluid 12 and passing upward into the first chamber 70 having the first filter 30. The first filter 30 can have a cylindrical shape with the fluid 12 entering the center 56 of the first filter 30 and passing through the first filter 30 toward the boundary 54. The fluid 12 can pass upwards and back toward the center 56 passing through the active matrix 58 back to the center 56. At the end of the second chamber 72 after traveling axially, the fluid 12 can proceed toward the boundary 54 and upward into the third chamber 74. Passing through the second filter 90 toward the center 56, the fluid 12 can move upward and exit the outlet 68.

Referring to FIG. 4, the cannister 52 in some embodiments can have an inlet 66 receiving the fluid 12 and passing downward into the first chamber 70 having the first filter 30. The first filter 30 can have a cylindrical shape with the fluid 12 entering the center 56 of the first filter 30 and passing through the first filter 30 toward the boundary 54. The fluid 12 can pass downwards and back toward the center 56 passing through the active matrix 58 back to the center 56. At the end of the second chamber 72 after travelling axially, the fluid 12 can proceed toward the boundary 54 and downward into the third chamber 74. Passing through the second filter 90 toward the center 56, the fluid 12 can move downward and exit the outlet 68.

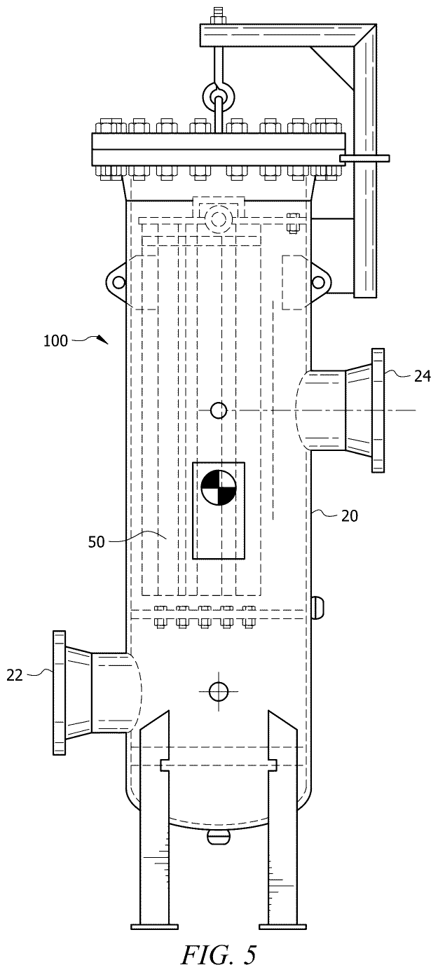

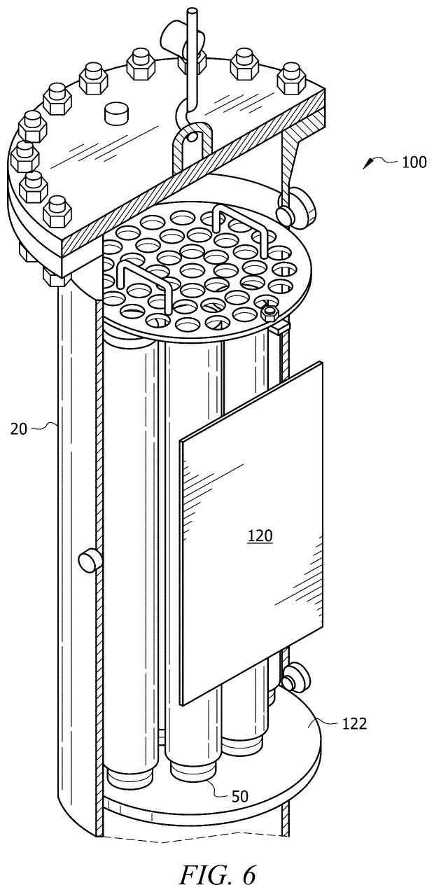

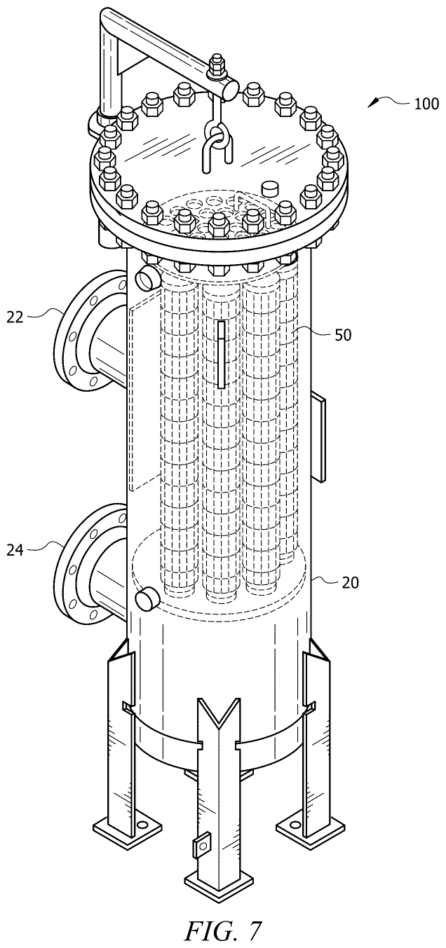

Referring to FIGS. 5-7, a vessel 20 can contain a plurality of containers 100. Each container 50 of the plurality can be the same as or similar to the containers as described above. The use of multiple containers instead of one large container facilitates the maintenance of a filter assembly by reducing the weight, and hence potential injury, for operators replacing each of the containers 50. This can be especially useful when the fluid being filtered is a liquid and a portion of the liquid can remain in the filter during a replacement, thereby increasing the original filter weight. The vessel 20 can include an inlet 22 and an outlet 24 for the fluid, which can be on opposite sides of the vessel 20 as depicted in FIG. 5 or the same side as depicted in FIG. 7. The vessel 20 can include a baffle 120 and a support plate 122, as depicted in FIG. 6. The fluid flow can be generally up-flow in these embodiments.

When a plurality of containers 50 are present, the support plate 122 and an upper baffle plate can be used to retain the plurality of containers 50 in position within the vessel 20. The plates can be used to position the plurality of containers 50 in a parallel flow configuration so that a portion of the entering fluid would pass through each of the plurality of containers 50. This configuration can be useful in providing additional filtration capacity for the active matrix while also providing continued service in the event that one or more of the particulate filters becomes loaded or clogged during use. In this situation, the fluid can pass through the other containers 50 until one or more of the containers are replaced.

In some aspects, the plates in the vessel 20 can be used with one or more conduits to form one or more serial flow paths through a plurality of the containers 50. In this embodiment, each of the containers 50 may be as described above and have a pre-filter, active matrix, and post filter, and/or one of the more of the containers 50 may only have one particular filter or only an active matrix. For example, a serial arrangement could provide a first container 50 having a pre-filter for particulate filtration, with the same container or a subsequent container having the active matrix. The last container in the series can have a post-filter for particulate filtration. A serial arrangement an allow for replacement of one of the filter or absorbent elements without replacing the entire set of containers 50.

Having described various systems and methods herein, certain embodiments can include, but are not limited to:

In a first aspect, a fluid filter assembly comprises a container comprising an active matrix therein for purifying a fluid; a first filter upstream of the active matrix; and a second filter downstream of the active matrix, wherein the active matrix and the second filter are comprised in a vessel.

A second aspect can include the fluid filter assembly of the first aspect, wherein container comprises a cannister and the active matrix is arranged radially in the cannister.

A third aspect can include the fluid filter assembly of the first aspect or the second aspect, wherein the active matrix comprises an adsorbent material.

A fourth aspect can include the fluid filter assembly of any of the proceeding aspects, wherein the adsorbent material comprises a fuller's earth, a clay, a diatomaceous earth, one or more absorbent resin beads, a macroreticular resin, an ion exchange resin, a catalyst, a molecular sieve, an activated carbon, or a combination thereof.

A fifth aspect can include the fluid filter assembly of any of the proceeding aspects, wherein the adsorbent material comprises an activated carbon.

A sixth aspect can include the fluid filter assembly of any of the proceeding aspects, wherein each of the first filter and the second filter, independently, comprises a pleated filter element, a non-pleated filter element, or a combination thereof.

A seventh aspect can include the fluid filter assembly of any of the proceeding aspects, wherein the container further comprises the first filter coupled to and upstream of the active matrix.

A eighth aspect can include the fluid filter assembly of any of the proceeding aspects, wherein the container further comprises the second filter coupled to and downstream of the active matrix.

A ninth aspect can include the fluid filter assembly of any of the proceeding aspects, wherein the first filter is comprised in another vessel.

A tenth aspect can include the fluid filter assembly of any of the proceeding aspects, wherein each of the first filter and the second filter comprises a particulate filter.

An eleventh aspect can include the fluid filter assembly of any of the proceeding aspects, wherein the container is a first container and a second container comprises the second filter.

A twelfth aspect can include the fluid filter assembly of any of the proceeding aspects, wherein the container comprises the first filter in a first chamber coupled to and upstream of the active matrix in a second chamber and the second filter in a third chamber coupled to and downstream of the active matrix in the second chamber.

A thirteenth aspect can include the fluid filter assembly of any of the proceeding aspects, wherein the first chamber is integrally formed with the second chamber and the third chamber is integrally formed with the second chamber.

A fourteenth aspect can include the fluid filter assembly of any of the proceeding aspects, wherein the container comprises a canister.

A fifteenth aspect can include the fluid filter assembly of any of the proceeding aspects, wherein the container is a first container comprising the active matrix, and the vessel comprises a second container comprising the second filter, wherein the first container and the second container are in substantially a same plane.

A sixteenth aspect can include the fluid filter assembly of any of the proceeding aspects, wherein the container forms a handle at an end.

In a seventeenth aspect, a process for purifying a fluid comprises: passing the fluid to a first filter to obtain a filtered fluid; passing the filtered fluid to a container comprising an active matrix therein to obtain a purified fluid; and passing the purified fluid to a second filter for removing active matrix fines to obtain a purified product, wherein the container and the second filter are comprised in a vessel.

An eighteenth aspect can include a process of the seventeenth aspect, wherein the first filter is comprised in another vessel.

A nineteenth aspect can include a process of the seventeenth aspect or the eighteenth aspect, wherein the first filter is comprised in the container and coupled to the active matrix.

A twentieth aspect can include a process of any one of the seventeenth to nineteenth aspects, wherein the first filter, the active matrix, and the second filter are comprised in the container, and the first filter is coupled upstream and the second filter is coupled downstream to the active matrix.

A twenty-first aspect can include a process of any one of the seventeenth to twentieth aspects, wherein the active matrix comprises an adsorbent material.

A twenty-second aspect can include a process of any one of the seventeenth to twenty-first aspects, wherein the adsorbent material comprises a fuller's earth, a clay, a diatomaceous earth, one or more absorbent resin beads, a macroreticular resin, an ion exchange resin, a catalyst, a molecular sieve, an activated carbon, or a combination thereof.

A twenty-third aspect can include a process of any one of the seventeenth to twenty-second aspects, wherein the active matrix adsorbs impurities.

A twenty-fourth aspect can include a process of any one of the seventeenth to twenty-third aspects, wherein the adsorbent material comprises an activated carbon.

A twenty-fifth aspect can include a process of any one of the seventeenth to twenty-fourth aspects, wherein each of the first filter and the second filter, independently, comprises a pleated filter element, a non-pleated filter element, or a combination thereof.

A twenty-sixth aspect can include a process of any one of the seventeenth to twenty-fifth aspects, wherein the first filter removes solid contaminates from the fluid, wherein the solid contaminates comprise one or more solid impurities, decomposition products, color bodies, or a combination thereof.

A twenty-seventh aspect can include a process of any one of the seventeenth to twenty-sixth aspects, wherein the fluid comprises a solvent.

A twenty-eighth aspect can include a process of any one of the seventeenth to twenty-seventh aspects, wherein the solvent comprises a glycol, optionally comprising polyethylene glycol.

A twenty-ninth aspect can include a process of any one of the seventeenth to twenty-eighth aspects, wherein the fluid passes through an inlet and radially exits the first filter, radially passes through the active matrix material toward a center of the container, passes axially and then radially through the active matrix outwardly to enter the second filter, and passes toward the center of the container prior to exiting the container.

In a thirtieth aspect, a container for purifying a fluid comprises: a first filter contained within a first chamber; an absorbent matrix contained within a second chamber; a second filter contained within a third chamber, wherein the first chamber is coupled to and upstream of the second chamber and the second filter in the third chamber is coupled to and downstream of the second chamber.

A thirty-first aspect of the thirtieth aspect, wherein the first chamber forms an inlet proximate to a center of the first chamber adapted for receiving a fluid for passing radially outward and through the filter, the second chamber adapted to receive the fluid at a boundary of the first chamber and channel the fluid inwardly, axially, and then outwardly toward the third chamber; and the third chamber adapted to receive the fluid at the boundary and channel the fluid inwardly to pass through the second filter and exit proximate to the center of the third chamber.

A thirty-second aspect of the thirtieth aspect or the thirty-first aspect, wherein the container is configured for up-flow.

A thirty-third aspect of the thirtieth aspect or the thirty-second aspect, wherein the container is configured for down-flow.

A thirty-fourth aspect of any one of the thirtieth to thirty-third aspects, further forming a handle at one end.

A thirty-fifth aspect of any one of the thirtieth to thirty-fourth aspects, wherein the second chamber is formed integrally with the first chamber and the third chamber.

A thirty-sixth aspect of any one of the thirtieth to thirty-fifth aspects, wherein the container comprises a cannister.

A vessel comprising a plurality of containers of any one of the thirtieth to thirty-sixth aspects.

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g., a screw, a nail, a staple, or a rivet; an adhesive; or a solder.

As used herein, the term “and/or” can mean one or more of items in any combination in a list, such as “A and/or B” means “A, B, or the combination of A and B”.

What is claimed is:

1. A fluid filter assembly, comprising:
a container comprising an active matrix configured to remove a portion of a fluid;
a first filter upstream of the active matrix, wherein the first filter is configured to remove a particulate material from the fluid; and
a second filter downstream of the active matrix, wherein the active matrix and the second filter are comprised in a vessel.

2. The fluid filter assembly of claim 1, wherein the container comprises a cannister and the active matrix is arranged radially in the cannister.

3. The fluid filter assembly of claim 2, wherein the active matrix comprises an adsorbent material.

4. The fluid filter assembly of claim 3, wherein the adsorbent material comprises a fuller's earth, a clay, a diatomaceous earth, one or more absorbent resin beads, a macroreticular resin, an ion exchange resin, a catalyst, a molecular sieve, an activated carbon, or a combination thereof.

5. The fluid filter assembly of claim 3, wherein the adsorbent material comprises an activated carbon.

6. The fluid filter assembly of claim 1, wherein each of the first filter and the second filter, independently, comprises a pleated filter element, a non-pleated filter element, or a combination thereof.

7. The fluid filter assembly of claim 1, wherein the container further comprises the first filter coupled to and upstream of the active matrix.

8. The fluid filter assembly of claim 1, wherein the container further comprises the second filter coupled to and downstream of the active matrix.

9. The fluid filter assembly of claim 1, wherein the first filter is disposed in a second vessel.

10. The fluid filter assembly of claim 1, wherein each of the first filter and the second filter comprises a particulate filter.

11. The fluid filter assembly of claim 1, wherein the container is a first container and a second container comprises the second filter.

12. The fluid filter assembly of claim 1, wherein the container comprises the first filter in a first chamber coupled to and upstream of the active matrix in a second chamber and the second filter in a third chamber coupled to and downstream of the active matrix in the second chamber.

13. The fluid filter assembly of claim 12, wherein the first chamber is integrally formed with the second chamber and the third chamber is integrally formed with the second chamber.

14. The fluid filter assembly of claim 1, wherein the container comprises a canister.

15. The fluid filter assembly of claim 1, wherein the container is a first container comprising the active matrix, and the vessel comprises a second container comprising the second filter, wherein the first container and the second container are in substantially a same plane.

16. The fluid filter assembly of claim 1, wherein the container forms a handle at an end.

17. A process for purifying a fluid, comprising:
passing the fluid to a first filter;
removing a portion of any particulates in the fluid in the first filter to obtain a filtered fluid;
passing the filtered fluid to a container comprising an active matrix therein;
removing one or more chemical components of the fluid with the active matrix to obtain a purified fluid; and
passing the purified fluid to a second filter for removing active matrix fines to obtain a purified product, wherein the container and the second filter are comprised in a vessel.

18. The process of claim 17, wherein the first filter, the active matrix, and the second filter are comprised in the container, and the first filter is coupled upstream and the second filter is coupled downstream to the active matrix.

19. The process of claim 17, wherein the active matrix comprises an adsorbent material.

20. A container for purifying a fluid, comprising:
a first filter contained within a first chamber;
an absorbent matrix contained within a second chamber;
a second filter contained within a third chamber,
wherein the first chamber is coupled to and upstream of the second chamber and the second filter in the third chamber is coupled to and downstream of the second chamber.
